(19) United States
(12) Patent Application Publication
(10) Pub. No.: US 2008/0101426 A1
(43) Pub. Date: May 1, 2008

(54) LASER BEAM SOURCE DEVICE AND IMAGE DISPLAY APPARATUS INCLUDING THE LASER BEAM SOURCE DEVICE

(75) Inventors: Akira KOMATSU, Kamiing-gun (JP); Kunihiko YANO, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/834,972

(22) Filed: Aug. 7, 2007

(30) Foreign Application Priority Data
Oct. 30, 2006 (JP) 2006-293634
Jun. 4, 2007 (JP) 2007-147742

(51) Int. Cl. H01S 3/10; G02B 5/08

(52) U.S. Cl. 372/28; 359/839

(57) ABSTRACT

A laser beam source device includes a light source that emits light of a first wavelength, a wavelength converting element that converts a wavelength of the light of the first wavelength entered into a second wavelength, a multi-layer film mirror having a characteristic of reflecting light of the first wavelength and transmitting light of the second wavelength, a band-pass filter having a band-pass characteristic near the first wavelength is formed, a reflection mirror that branches the light transmitted through the multi-layer film mirror to the first optical path and a second optical path, a laser-power measuring unit that measures power of the light branched to the second optical path, and a control unit that performs angle adjustment for displacing a tilt angle of the band-pass filter.

### BACKGROUND

1. Technical Field

The present invention relates to a laser beam source device that emits a laser beam and an image display apparatus including the laser beam source device.

2. Related Art

In recent years, a laser beam source device that wavelength-converts oscillating light of a semiconductor laser beam source and uses the oscillating light are widely used in the filed of optoelectronics such as optical communication, optical applied measurement, and optical display. As such a laser beam source device, there is known a second harmonic generation device that includes a semiconductor laser beam source, on one facet of which a mirror structure is formed and on a surface opposed to one facet of which a no-reflection structure is formed, and a non-linear optical member, on a light oscillating surface of which a mirror structure is formed and on a surface opposed to the light oscillating surface of which a no-reflection structure is formed, wherein a resonator structure is formed between the mirror structures of the laser beam source device and the non-linear optical member and it is possible to generate green light and blue light (see, for example, Japanese Patent No. 3300429).

In order to stably supply a laser beam having a narrow wavelength width, there is proposed an external resonant laser that includes a semiconductor laser oscillator that emits a laser beam of a predetermined wavelength and an external resonator that resonates the laser beam emitted from the laser oscillator, wherein a photopolymer volume hologram is provided in the external resonator and the photopolymer volume hologram diffracts the laser beam emitted from the laser oscillator to make the laser beam incident on an optical system in the resonator and selectively transmits a laser beam of a predetermined wavelength to emit the laser beam to the outside (see, for example, JP-A-2001-284718).

However, in the second harmonic generation device of the past disclosed in Japanese Patent No. 3300429, since a laser beam is not narrow-banded, an oscillation wavelength of the semiconductor laser beam source fluctuates because of a temperature change. An oscillating wavelength width of a laser beam emitted from the laser beam source is wide compared with an allowance of a converted wavelength of a wavelength converting element (same as the non-linear optical member). Thus, there is a large amount of light in wavelength regions not wavelength-converted and conversion efficiency is low.

On the other hand, the photopolymer volume hologram used in the external resonant laser disclosed in JP-A-2001-284718 is, for example, an element that has a large number of interference patterns having different refractive indexes formed in a layered shape in resin and narrow-bands a laser beam of an oscillation wavelength to reflect the laser beam. Although it is possible to simply form the external resonant laser, the photopolymer volume hologram is an expensive element. Therefore, manufacturing cost is high.

### SUMMARY

An advantage of some aspects of the invention is to provide a laser beam source device that efficiently controls the fall in power of an output beam even if a temperature change or the like occurs, has high efficiency of light usage, and has stable power. Another advantage of some aspects of the invention is to provide an image display apparatus in which efficiency of light usage is improved by using such a laser beam source device.

According to an aspect of the invention, there is provided a laser beam source device including a light source that emits light of a first wavelength, a multi-layer film mirror that reflects the light emitted from the light source and forms a resonator, the multi-layer film mirror having a dielectric multi-layer film having a characteristic of reflecting light of the first wavelength and transmitting light of a second wavelength, a wavelength converting element that is provided between the light source and the multi-layer film mirror on a first optical path formed by light emitted from the light source and converts a wavelength of a part of the light of the first wavelength emitted into the second wavelength different from the first wavelength, a band-pass filter that is provided between the light source and the multi-layer film mirror on the first optical path formed by the light emitted from the light source and in which a band-pass filter multi-layer film having a band-pass characteristic near the first wavelength is formed, a reflection mirror that branches the light transmitted through the multi-layer film mirror to the first optical path and a second optical path, a laser-power measuring unit that measures power of the light branched to the second optical path, and a control unit that performs, on the basis of an output signal of the laser-power measuring unit, angle adjustment for displacing a tilt angle of the band-pass filter with respect to the first optical path.

In such a structure, the wavelength converting element is provided in a resonant structure formed by the light source and the multi-layer film mirror. The light of the second wavelength converted in a course of being reflected by the multi-layer film and traveling to the light source is reflected by the band-pass filter and used. Thus, it is possible to efficiently reduce the fall in power of the output light. The angle adjustment for displacing the tilt angle of the band-pass filter with respect to the first optical path is performed on the basis of the output signal of the laser-power measuring unit that measures power of a laser beam. Thus, even when the wavelength of the light of the first wavelength emitted from the light source changes because of a temperature change or the like, it is possible to adjust the wavelength to the converted wavelength of the wavelength converting element. Moreover, the multi-layer film mirror has the characteristic of reflecting the light of the first wavelength and transmitting the light of the second wavelength. Thus, it is possible to efficiently extract the light of the second wavelength converted by the wavelength converting element while confining the oscillating light of the light source in the resonant structure.

According to the aspect of the invention, it is possible to obtain the laser beam source device that efficiently controls the fall in power of output light, has high efficiency of light usage, and has stable power.

In the laser beam source device according to the aspect of the invention, preferably, the dielectric multi-layer film that forms the multi-layer film mirror is formed on a surface on an emission side of the wavelength converting element.

In such a structure, the resonant structure is formed by the light source and the dielectric multi-layer film formed on the surface on the emission side of the wavelength converting element and the light of the second wavelength converted in a course of being reflected by the dielectric multi-layer film and traveling to the light source is reflected by the band-pass filter and used. Thus, it is possible to efficiently reduce the fall in power of output light. Since the dielectric multi-layer film is formed on the surface of the emission side of the wavelength converting element, the laser beam source device reduced in the number of components, reduced in cost, and reduced in size is obtained. Further, since the dielectric multi-layer film has the characteristic of reflecting the light of the first wavelength and transmitting the light of the second wavelength, it is possible to efficiently extract the light of the second wavelength converted by the wavelength converting element while confining the oscillating light of the light source in the resonant structure. Moreover, the angle adjustment for displacing the tilt angle of the band-pass filter with respect to the first optical path is performed on the basis of the output signal of the laser-power measuring unit that measures power of a laser beam. Thus, even when the wavelength of the light of the first wavelength emitted from the light source changes because of a temperature change or the like, it is possible to adjust the wavelength to the converted wavelength of the wavelength converting element.

According to the aspect of the invention, it is possible to obtain the laser beam source device that efficiently controls the fall in power of output light, has high efficiency of light usage, and has stable power.

In the laser beam source device according to the aspect of the invention, preferably, the band-pass filter is disposed between the light source and the wavelength converting element.

In such a structure, the wavelength converting element is provided in the resonant structure formed by the light source and the multi-layer film mirror. Thus, the wavelength of the light not converted into the second wavelength by the wavelength converting element is converted into the second wavelength in a course of the light being reflected by the multi-layer film mirror and traveling to the light source. The light is reflected and emitted by the band-pass filter. Thus, it is possible to efficiently control the fall in power of output light and improve efficiency of light usage.

In the laser beam source device according to the aspect of the invention, preferably, the band-pass filter is disposed between the multi-layer film mirror and the wavelength converting element.

In such a structure, the light of the second wavelength as a part of the light reflected by the multi-layer film mirror is reflected and emitted by the band-pass filter in a course of traveling to the light source. Thus, it is possible to reduce a loss of light due to an increase in the length of the optical path or an increase in the number of times of passage through optical elements and improve efficiency of light usage.

In the laser beam source device according to the aspect of the invention, preferably, the band-pass filter multi-layer film further has a characteristic of reflecting a laser beam of the second wavelength.

In such a structure, the band-pass filter multi-layer film has the characteristic of reflecting the laser beam of the second wavelength. Thus, the laser beam of the second wavelength generated by the wavelength converting element from a laser beam of the first wavelength reflected by the multi-layer film mirror and fed back to and made incident on the wavelength converting element is reflected on the band-pass filter multi-layer film, passes through the wavelength converting element, and is emitted from the laser beam source device. Thus, it is possible to efficiently control the fall in power of output light and improve efficiency of light usage.

In the laser beam source device according to the aspect of the invention, preferably, the band-pass filter multi-layer film further has a characteristic of transmitting the laser beam of the second wavelength.

In such a structure, the band-pass filter multi-layer film has the characteristic of transmitting the laser beam of the second wavelength. Thus, the laser beam of the second wavelength generated by the wavelength converting element is transmitted through the band-pass multi-layer film and emitted from the laser beam source device. Thus, it is possible to efficiently control the fall in power of output light and improve efficiency of light usage.

In the laser beam source device according to the aspect of the invention, preferably, high refractive index layers H and low refractive index layers L are alternately stacked in the band-pass filter multi-layer film and, when the first wavelength is λ, optical film thicknesses of the layers are 0.236 λH, 0.355 λL, 0.207 λH, 0.203 λL (0.25 λH, 0.25 λL)n, 0.5 λH, (0.25 λL, 0.25 λH)n, 0.266 λL, 0.255 λH, 0.248 λL, 0.301 λH, and 0.631 λL in order from the wavelength converting element side. Here, n is a value in a range of 3 to 10 and indicates the number of repetition of repeated stacking of the layers in the parentheses.

In such a structure, the high refractive index layers H and the low refractive index layers L are alternately stacked in the band-pass filter multi-layer film. Thus, it is possible to narrow-band the light of the first wavelength having a band-pass characteristic near the first wavelength and emitted from the light source. Consequently, it is possible to improve conversion efficiency of the wavelength conversion in the wavelength converting element.

In the laser beam source device according to the aspect of the invention, preferably, the light source includes plural arrayed light emitting sections.

In the aspect of the invention, even if the light source in which the light emitting sections are arrayed in this way is used, areas of the band-pass filter multi-layer film, the wavelength converting element, and light incidence/exit facets of the multi-layer film mirror and the reflection mirror only have to be expanded to areas corresponding to the array. In this way, in the aspect of the invention, even if the light emitting sections are arrayed in the light source, it is possible to cope with the array with a simple structure without causing an excessive increase in size of the device. Thus, in the aspect of the invention, even if the light emitting sections are arrayed in the light source, while keeping the effect that it is possible to efficiently control the fall in power of output light and obtain the laser beam source device having high efficiency of light usage and stable power, it is possible to efficiently link an increase in a light amount by the arraying to an increase in power of output light.

In the laser beam source device according to the aspect of the invention, preferably, the wavelength converting element is a wavelength converting element of a quasi phase matching type.

Since the wavelength converting element of the quasi phase matching type has conversion efficiency higher than that of wavelength converting elements of other types, it is possible to further improve the effect of the aspect of the invention.

According to another aspect of the invention, there is provided an image display apparatus including the laser beam source device described above and an optical modulation device that modulates, according to image information, a laser beam emitted from the laser beam source device.

Since the laser beam source device is used in such an image display apparatus, it is possible to improve efficiency of usage of a laser beam.

### BRIEF DESCRIPTION OF THE DRAWINGS

The invention will be described with reference to the accompanying drawings, wherein like numbers reference like elements.

FIG. 1 is a diagram showing a schematic structure of a laser beam source device according to a first embodiment of the invention.

FIG. 2 is a sectional view schematically showing a structure of a light source.

FIG. 3 is a graph showing an example of a spectral transmission characteristic of a band-pass filter multi-layer film.

FIG. 4 is a sectional view schematically showing a structure of a wavelength converting element.

FIG. 5 is a graph showing a shift characteristic of a transmission wavelength due to displacement of a tilt angle of a band-pass filter.

FIG. 6 is a diagram showing a schematic structure of a laser beam source device according to a second embodiment of the invention.

FIG. 7 is a diagram showing a schematic structure of a laser beam source device according to a third embodiment of the invention.

FIGS. 8A and 8B are diagrams schematically snowing light sources in which light emitting sections are arrayed.

FIG. 9 is a diagram showing a schematic structure of an optical system of a projector.

### DESCRIPTION OF EXEMPLARY EMBODIMENTS

Exemplary embodiments of the invention will be hereinafter explained with reference to the drawings.

### First Embodiment

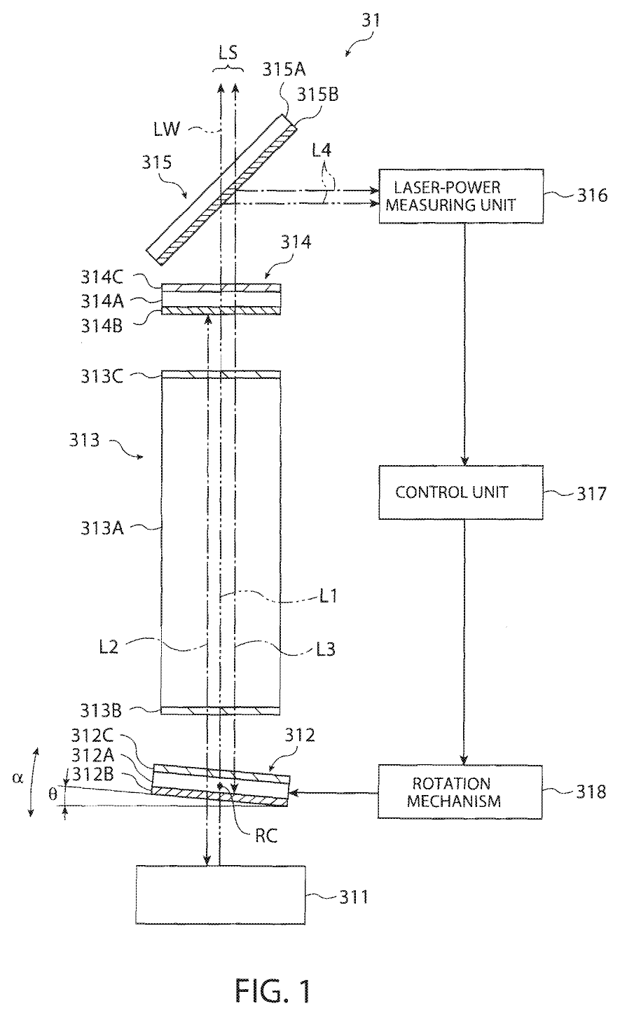

FIG. 1 is a diagram showing a schematic structure of a laser beam source device according to a first embodiment of the invention. A laser beam source device 31 includes a light source 311, a band-pass filter 312, a wavelength converting element 313, a multi-layer film mirror 314, a reflection mirror 315, a laser-power measuring unit 316, a control unit 317, and a rotation mechanism 318. Among these components, the band-pass filter 312, the wavelength converting element 313, the multi-layer film mirror 314, and the reflection mirror 315 are provided in this order from the light source 311 side on an optical path LW serving as a first optical path of a laser beam emitted from the light source 311.

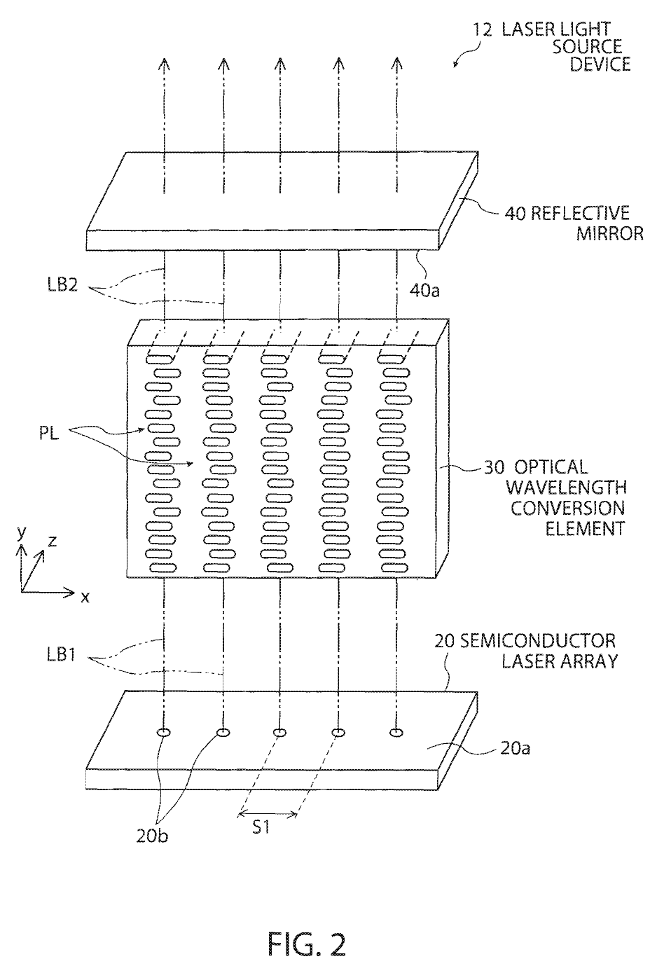

The light source 311 emits light of a first wavelength. FIG. 2 is a sectional view schematically showing a structure of the light source 311. The light source 311 shown in FIG. 2 is a so-called surface-emitting semiconductor laser. The light source 311 has a substrate 400 formed by, for example, at least a semiconductor wafer, a mirror layer 311A that is formed on the substrate 400 and has a function of a reflection mirror, and a laser medium 311B stacked on the surface of the mirror layer 311A.

The mirror layer 311A is formed by a layered product of dielectrics having a nigh refractive index and dielectrics having a low refractive index which is formed by, for example, CVD (Chemical Vapor Deposition) on the substrate 400. The thicknesses of the respective layers forming the mirror layer 311A, materials of the respective layers, and the number of layers are optimized according to a wavelength (the first wavelength) of light emitted from the light source 311 and are set as conditions under which reflected lights interfere with one another and intensify one another.

The laser medium 311B is formed on the surface of the mirror layer 311A. Not-shown current feeding means is connected to the laser medium 311B. When an electric current of a predetermined amount is fed from the current feeding means, the laser medium 311B emits the light of the first wavelength. When the light of the first wavelength resonates between the mirror layer 311A and the multi-layer film 314 shown in FIG. 1, the laser medium 311B amplifies light of a specific wavelength (the first wavelength). In other words, light reflected by the mirror layer 311A and the multi-layer film mirror 314 described later resonates with light emitted by the laser-medium 311B anew and is amplified. The light is emitted from a light emission facet of the laser medium 311B in a direction substantially orthogonal to the mirror layer 311A and the substrate 400.

As shown in FIG. 1, the band-pass filter 312 is disposed to be opposed to the light source 311 on the optical path LW of the light emitted from the light source 311. The band-pass filter 312 has a band-pass characteristic near the first wavelength. The band-pass filter 312 selectively transmits only light of a set specific wavelength in light emitted from the light source 311 and reflects laser beams other than the light. In other words, the band-pass filter 312 has a function of narrow-banding the light emitted from the light source 311. The light of the specific wavelength selectively transmitted through the band-pass filter 312 is light having a half width of about 0.5 nm in the first wavelength.

The band-pass filter 312 is formed such that a tilt angle θ with respect to a laser beam emission surface (a surface substantially orthogonal to the optical path LW) of the light source 311, i.e., a tilt angle with respect to the optical path LW is displaceable by the rotation mechanism 318 described later.

The band-pass filter 312 has a band-pass filter multi-layer film 312B on one surface (an incidence surface) of a glass substrate 312A and has an anti-reflective (AR) film 312C for preventing reflection of light on the other surface (an emission surface). The band-pass filer 312 is disposed with the surface on which the band-pass filter multi-layer film 312B is formed set to face the light source 311 side. The function of the band-pass filter 312 is realized by the band-pass filter multi-layer film 312B.

The band-pass filter 312 may be disposed with the surface on which the AR film 312C is formed set to face the light source 311 side.

As a film structure of the band-pass filter multi-layer film 312B, the high refractive index layers H and the low refractive index layers L are alternately stacked. When the oscillation wavelength is λ, optical film thicknesses of the layers are 0.236 λH, 0.355 λL, 0.207 λH, 0.203 λL (0.25 λR, 0.25 λL)n, 0.5 λR, (0.25 λL, 0.25 λH)n, 0.266 λL, 0.255 λR, 0.248 λL, 0.301 λR, and 0.631 λL in order from the wavelength converting element side. Here, n is a value in a range of 3 to 10 and indicates the number of repetition of repeated stacking of the layers in the parentheses.

As a material of the high refractive index layers H, one kind is selected out of substances such as Ta₂O₅, Nb₂O₅, TiO₂, and ZrO₂ that are transparent in a wavelength region in use and eco-friendly. As a material of the low refractive index layers L, similarly, one kind is selected out of substances such as SiO₂ and MgF₂ that are eco-friendly.

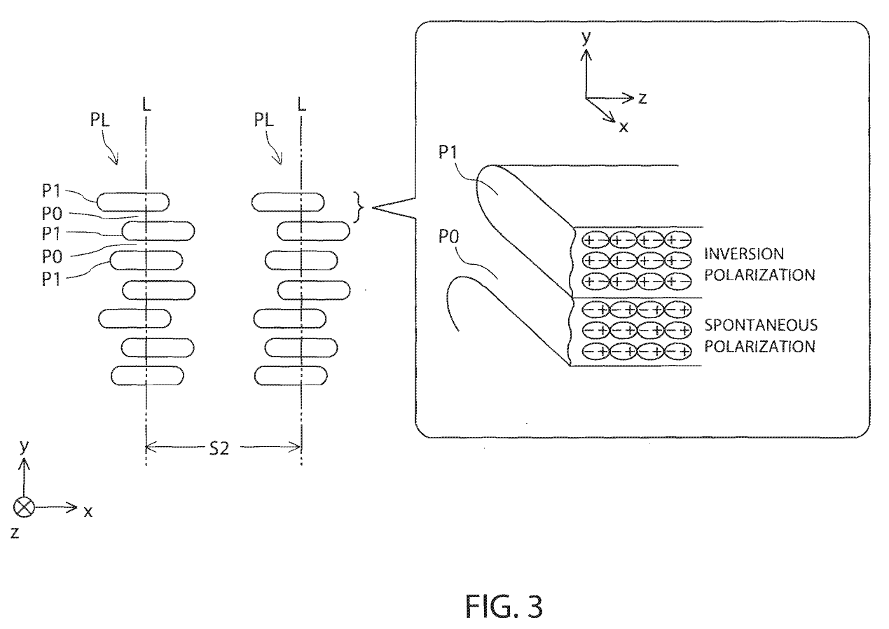

FIG. 3 is a graph showing an example of a spectral transmission characteristic of the band-pass filter multi-layer film 312B formed as described above. The abscissa of the graph indicates a wavelength (nm) and the ordinate indicates a transmittance (%).

The band-pass filter multi-layer film 312B has a characteristic of reflecting light of a converted wavelength (the second wavelength) converted by the wavelength converting element 313 (a wavelength converting section 313A) described later. It is desirable that the band-pass filter multi-layer film 312B has a reflectance equal to or higher than 80% with respect to the light of the second wavelength.

The wavelength converting element 313 converts a wavelength of incident light into a wavelength (the second wavelength) that is about a half of the wavelength. As shown in FIG. 1, the wavelength converting element 313 is provided between the band-pass filter 312 and the multi-layer film mirror 314 on the optical path LW of the light emitted from the light source 311.

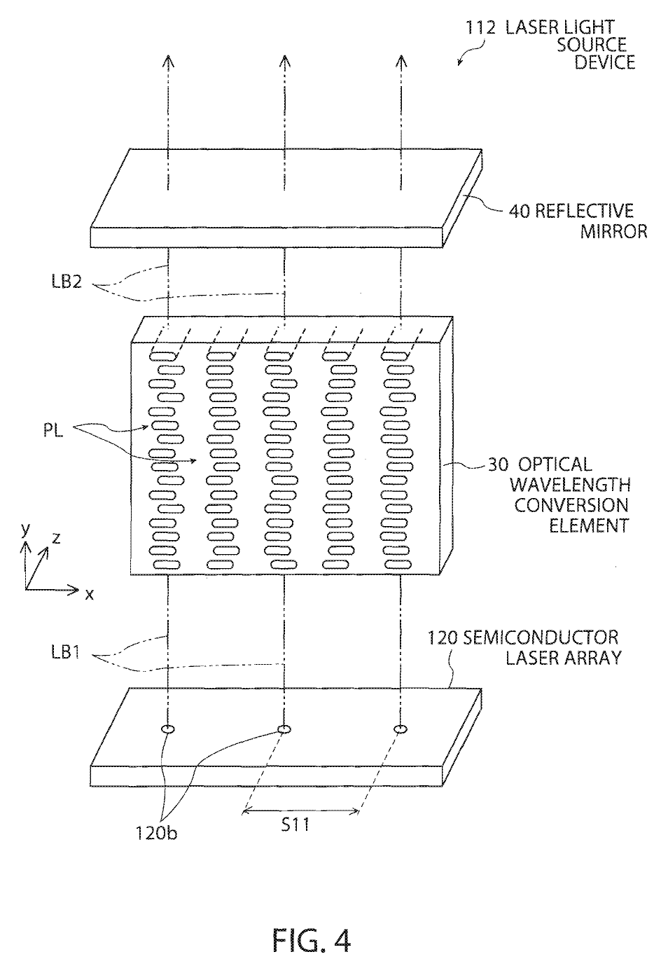

FIG. 4 is a sectional view schematically showing a structure of the wavelength converting element 313. The wavelength converting element 313 is formed in, for example, a square pole shape. The wavelength converting element 313 has the wavelength converting section 313A, has an anti-reflective (AR) film 313B on a surface on the light source 311 side (an incidence facet) of the wavelength converting section 313A, and has an anti-reflective (AR) film 313C on a surface on the multi-layer film mirror 314 side (an emission facet) of the wavelength converting section 313A.

The wavelength converting section 313A is a second harmonic generation (SHG) element that generates a second harmonic of incident light. The wavelength converting section 313A has a periodical polarization inverting structure. The wavelength converting section 313A converts a wavelength of incident light into a wavelength (the second wavelength) that is about a half of the wavelength according to wavelength conversion by quasi phase matching (QPM). For example, when the wavelength (the first wavelength) of the light emitted from the light source 311 is 1064 nm (near infra-red), the wavelength converting section 313A converts the wavelength into a wavelength (the second wavelength) of 532 nm that is half the wavelength and generates green light. However, in general, wavelength conversion efficiency of the wavelength converting section 313A is about several %. In other words, not all lights emitted from the light source 311 are converted into light of the second wavelength.

The periodical polarization inverting structure is formed in a crystal substrate of an inorganic nonlinear optical material such as lithium niobate (LN: LiNbO₃) or a lithium tantalum (LT: LiTaO₃). Specifically, the periodical polarization inverting structure is a structure in which two kinds of a large number of areas 313Aa and 313Ab having polarization directions inverted from each other are alternately formed at predetermined intervals in a direction substantially orthogonal to the light emitted from the light source 311 in the crystal substrate. A pitch of these two kinds of areas 313Aa and 313Ab is appropriately determined taking into account a wavelength of an incident light and a refractive index distribution of the crystal substrate.

In general, in a laser beam emitted from a semiconductor laser, plural vertical modes oscillate in a gain band. Wavelengths of the modes change because of influences of a temperature change and the like. In other words, an allowance of a wavelength of light converted by the wavelength converting element 313 is about 0.3 nm. The wavelength fluctuates about 0.1 nm/° C. with respect to a change in a service environmental temperature.

The AR films 313B and 313C are dielectric films made of, for example, at least a single layer or multiple layers. The AR films 313B and 313C transmit both the light of the first wavelength and the light of the second wavelength at, for example, a transmittance equal to or higher than 98%. The AR films 313B and 313C have a characteristic of reducing a loss of light at the time when the light is made incident on the wavelength converting element 313 or emitted from the wavelength converting element 313. However, the AR films 313B and 313C are not essential components in attaining the function of the wavelength converting element 313. Thus, the AR films 313B and 313C may be omitted. In other words, it is also possible to form the wavelength converting element 313 only with the wavelength converting section 313A.

As shown in FIG. 1, the multi-layer film mirror 314 is provided on an emission side of the wavelength converting element 313 on the optical path LW. The multi-layer film mirror 314 has a function of selectively reflecting the light of the first wavelength, causing the light to travel to the light source 311, and transmitting light of other wavelengths (including the second wavelength).

In the multi-layer film mirror 314, a dielectric multi-layer film 314B is formed on one surface (an incidence surface) of a glass substrate 314A serving as a transparent member and an anti-reflective film 314C for preventing reflection of light is formed on the other surface (an emission surface). The multi-layer film mirror 314 is disposed with the dielectric multi-layer film 314B set to face the wavelength converting element 313 side.

It is possible to form the dielectric multi-layer film 314B according to, for example, CVD. The thicknesses of the respective layers forming the multi-layer film, materials of the respective layers, and the number of layers are optimized according to a characteristic required. The function of the multi-layer film mirror 314 is realized by the dielectric multi-layer film 314B. A higher transmittance of the dielectric multi-layer film 314B with respect to the light of the second wavelength and a higher reflectance of the dielectric multi-layer film 314B with respect to the light of the first wavelength are better. The transmittance and the reflectance equal to or higher than 80% are necessary.

It is desirable that the glass substrate 314A as a transparent member has a high transmittance with respect to the light of the second wavelength that is transmitted through the glass substrate 314A. In this embodiment, the glass substrate 314A has a transmittance equal to or higher than 80%. It is desirable that the glass substrate 314A has a low transmittance with respect to the light of the first wavelength. In this embodiment, the glass substrate 314A has a transmittance equal to or lower than 20%. Consequently, it is possible to reduce a loss of the light of the first wavelength that is transmitted through the multi-layer film mirror 314.

The AR film 314C is not an essential component in attaining the function of the multi-layer film mirror 314. Thus, the AR film 314C may be omitted. In other words, it is also possible to constitute the multi-layer film mirror 314 with only the glass substrate 314A and the dielectric multi-layer film 314B.

As shown in FIG. 1, the reflection mirror 315 is provided on an emission side of the multi-layer film mirror 314 on the optical path LW. The reflection mirror 315 has a function of reflecting a part of the light of the second wavelength emitted from the multi-layer film mirror 314, e.g., about 0.5% of a laser power, and branches the light to a second optical path to the laser-power measuring unit 316.

In the reflection mirror 315, a reflection film 315B made of at least a dielectric, multi-layer film is provided on one surface of a glass substrate 315A. The reflection mirror 315 is disposed on the optical path LW to be tilted, for example, about 45° with respect to the optical path LW with the reflection film 315B set to face the multi-layer film mirror 314 side. The thicknesses of the respective layers of the multi-layer film forming the reflection film 315B, materials of the respective layers, and the number of layers are optimized according to a characteristic required. In the reflection mirror 315, an AR film may be provided on the other surface of the glass substrate 315A.

The laser-power measuring unit 316 has a light receiving sensor and a measurement circuit, which are not shown in the figure. The laser-power measuring unit 316 receives reflected light made incident thereon from the reflection mirror 315 and converts it to the electric signal and calculates a measurement value of a laser beam power by performing signal processing. As the light receiving sensor, it is possible to use a semiconductor photodiode or the like.

An output signal of the laser power measurement value obtained by the laser-power measuring unit 316 is delivered to the control unit 317.

The control unit 317 is constituted by a microcomputer including a CPU, a RAM, and a ROM. The control unit 317 performs control of the rotation mechanism 318 on the basis of the output signal of the laser power measurement value inputted from the laser-power measuring unit 316.

As shown in FIG. 1, the rotation mechanism 318 performs angle adjustment for displacing the tilt angle θ of the band-pass filter 312 on the optical path LW on the basis of a control signal inputted from the control unit 317.

The tilt angle θ is a tilt angle with respect to the laser beam emission surface (the surface substantially orthogonal to the optical path LW) of the light source 311. In other words, the tilt angle θ is a tilt angle with respect to the optical path LW. When the tilt angle θ is adjusted, a peak wavelength of the wavelength (the first wavelength) of the light transmitted through the band-pass filter 312 is adjusted. The angle adjustment of the tilt angle θ is performed by rotating the band-pass filter 312 as indicated by an arrow a in the figure with a substantial center point RC of the band-pass filter 312 as a rotation center using leverage of various rotation motors, an actuator, or a piezoelectric element.

A process until output light is obtained from the laser beam source device 31 will be explained with reference to FIGS. 1, 2, and 4.

When an electric current is fed to the laser medium 311B, the light source 311 emits the light of the first wavelength. The light of the first wavelength emitted from the light source 311 is made incident on the band-pass filter 312. In the band-pass filter 312, light having a wavelength width of about 0.5 nm in the light of the first wavelength is transmitted through the band-pass filter multi-layer film 312B. Light of wavelength widths other than the wavelength width is reflected on the band-pass filter multi-layer film 312B. In other words, narrow-banding of the light of the first wavelength made incident on the band-pass filter 312 is performed.

When the band-pass filter 312 is tilted with respect to the laser beam emission surface of the light source 311 and is disposed with the surface on which the band-pass filter multi-layer film 412B is formed set to face the light source 311 side, a laser beam reflected on the band-pass filter multi-layer film 312B is not made incident on the light source 311. Consequently, it is possible to prevent an unnecessary resonant structure from being generated between the band-pass filter 312 and the light source 311.

The light of the first wavelength transmitted through the band-pass filter multi-layer film 312B of the band-pass filter 312 is emitted to the wavelength converting element 313 and made incident on the wavelength converting element 313. The wavelength converting element 313 converts a wavelength of a part of the light of the first wavelength made incident thereon into a wavelength (the second wavelength) that is half the wavelength and emits the light to the multi-layer film mirror 314.

In the multi-layer film mirror 314, the light, which is converted into the light of the second wavelength, in the light emitted from the wavelength converting element 313 is transmitted through the dielectric multi-layer film 314B and emitted to the reflection mirror 315. On the other hand, the light (the light of the first wavelength), which is not converted into the light of the second wavelength, of the light emitted from the wavelength converting element 313 is reflected by the dielectric multi-layer film 314B and travels to the light source 311.

In the light, which is converted into the light of the second wavelength, transmitted through the dielectric multi-layer film 314B of the multi-layer film mirror 314 and emitted to the reflection mirror 315, light L4 equivalent to about 0.5% of a laser power of the light of the second wavelength made incident on the multi-layer film mirror 314 is reflected to the laser-power measuring unit 316 on the reflection film 315B of the reflection mirror 315. The other light of the second wavelength is transmitted through the reflection mirror 315 and emitted from the reflection mirror 315 (the laser beam source device 31) as a laser beam LS. The laser beam L4 reflected by the dielectric multi-layer film 314B is used for adjusting the tilt angle θ of the band-pass filter 312. The adjustment of the tilt angle θ will be described later.

On the other hand, the light of the first wavelength reflected by the dielectric multi-layer film 314B of the multi-layer film mirror 314 and traveling to the light source 311 passes through the wavelength converting element 313 again in a course of traveling to the light source 311. In the course of the passage, the wavelength of a part of the light is converted into the second wavelength.

The light transmitted through the wavelength converting element 313 is made incident on the band-pass filter 312.

In the band-pass filter 312, the light, which is converted into the light of the second wavelength by the wavelength converting element 313 in the course of being reflected by the dielectric multi-layer film 314B of the multi-layer film mirror 314 and traveling to the light source 311, is reflected by the band-pass filter multi-layer film 312B and travels to the multi-layer film mirror 314. On the other hand, the light (the light of the first wavelength), which is not converted into the light of the second wavelength by the wavelength converting element 313 in the course of being reflected by the dielectric multi-layer film 314B of the multi-layer film mirror 314 and traveling to the light source 311, is transmitted through the band-pass filter multi-layer film 312B and returns to the light source 311.

The light of the second wavelength reflected by the band-pass filter multi-layer film 312B and traveling to the multi-layer film mirror 314 travels through the wavelength converting element 313 and is emitted from the wavelength converting element 313 and transmitted through the multi-layer film mirror 314. Other than a part of the light reflected on the reflection mirror 315, the light is transmitted through the reflection mirror 315 and emitted from the laser beam source device 31 as the laser beam LS.

The light transmitted through the band-pass filter multi-layer film 312B and returning to the light source 311 is reflected by the mirror layer 311A and emitted from the light source 311 again. In this way, the light of the first wavelength travels back and forth between the light source 311 and the multi-layer film mirror 314. Consequently, the light resonates with light emitted anew in the laser medium 311B and is amplified. In other words, the laser beam source device 31 includes a resonant structure formed between the mirror layer 311A of the light source 311 and the multi-layer film mirror 314.

In FIG. 1, L1 indicates a laser beam that is emitted from the light source 311, converted into the light of the second wavelength by the wavelength converting element 313, transmitted through the multi-layer film mirror 314, and emitted from the reflection mirror 315 as the laser beam LS. L2 indicates light that is emitted from the light source 311, reflected by the band-pass filter multi-layer film 312B, and returns to the light source 311. L2 also indicates light that is transmitted through the band-pass filter multi-layer film 312B, emitted without being converted into the light of the second wavelength by the wavelength converting element 313, reflected by the multi-layer film mirror 314, and, without being converted into the light of the second wavelength by the wavelength converting element 313 in the course of traveling to the light source, transmitted through the band-pass filter multi-layer film 312B, and returns to the light source 311.

L3 indicates a laser beam that is reflected by the multi-layer film mirror 314, converted into the light of the second wavelength by the wavelength converting element 313 in the course of traveling to the light source 311, reflected by the band-pass filter multi-layer film 312B, transmitted through the multi-layer film mirror 314, and emitted from the reflection mirror 315 as the laser beam LS.

In FIG. 1, L1 to L3 are shown in different positions only for convenience of explanation. However, originally, L1 to L3 are present in the same position.

The adjustment of the tilt angle θ of the band-pass filter 312 will be explained.

In general, in light emitted from the semiconductor laser (the light source 311), plural vertical modes oscillate in a gain band. Wavelengths of the modes change because of influences of a temperature change or the like. A wavelength of light converted by the wavelength converting element 313 changes about 0.1 nm/° C. with respect to a temperature change.

The angle adjustment through displacement of the tilt angle θ of the band-pass filter 312 is performed for the purpose of coping with such a temperature change and obtaining a stable laser beam.

The adjustment, of the tilt angle θ of the band-pass filer 312 is performed on the basis of the light L4 of the second wavelength reflected on the reflection film 315B of the reflection mirror 315, travels to the second optical path, and is made incident on the laser-power measuring unit 316.

In the laser-power measuring unit 316, the light receiving sensor receives the light L4 made incident on the laser-power measuring unit 316 and converts the light L4 into an electric signal. A measurement value of a laser beam power is calculated in the measurement circuit on the basis of the electric signal.

An output signal of the laser power measurement value obtained by the laser-power measuring unit 316 is delivered to the control unit 317.

The control unit 317 executes a control program based on a laser power stored in the ROM and a shift characteristic of a wavelength due to the tilt angle θ. The control unit 317 outputs a control signal for displacing the band-pass filter 312 to the tilt angle θ corresponding to the output signal of the laser power measurement value obtained by the laser-poser measuring unit 316 to the rotation mechanism 318.

In the rotation mechanism 318, the actuator operates on the basis of the control signal inputted from the control unit 317. The band-pass filter 312 rotates a predetermined amount with the substantial center point RC as a rotation center. In this way, the angle adjustment for displacing the band-pass filter 312 to the predetermined tilt angle θ is performed.

An interval of measurement times of the laser-power measuring unit 316 and an operation frequency of the rotation mechanism 318 is appropriately determined taking into account a service environment and the like.

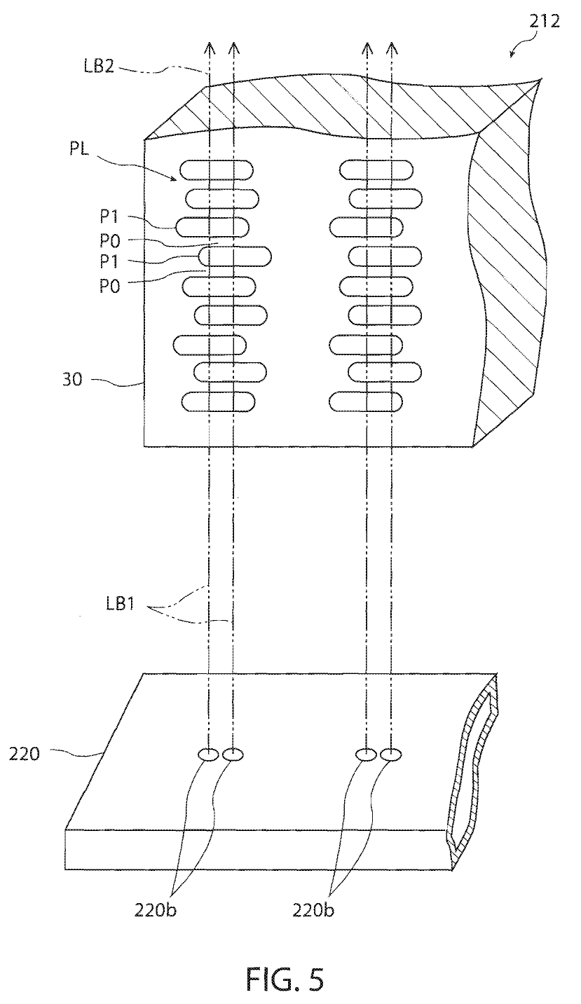

FIG. 5 is a graph showing a shift characteristic of a transmission wavelength due to displacement of the tilt angle θ. The abscissa of the graph indicates a wavelength (nm) and the ordinate indicates a transmittance (%). In the case of FIG. 5, a set wavelength of light emitted from the light source 311 is 1064 nm.

A curve “a” shown in FIG. 5 is a transmittance curve at the tilt angle θ of 0° of the band-pass filter 312. Similarly, a curve “b”, a curve “c”, a curve “d”, a curve “e”, and a curve “f” are transmittance curves at the tilt angles θ of 1°, 2° 3°, 4°, and 5°, respectively.

In FIG. 5, as the tilt angle θ of the band-pass filter 312 increases from 0° to 5°, a peak wavelength of light transmitted through the band-pass filer 312 shifts in a direction in which the peak wavelength decreases (a frequency increases).

The adjustment of the tilt angle θ of the band-pass filter 312 may be performed in a direction of tilt to the right or tilt to the left with respect to the laser beam emission surface of the light source 311.

The laser beam source device 31 according to this embodiment has the following effects.

(1) The angle adjustment for the band-pass filter 312 for displacing the tilt angle θ with respect to the optical path LW is performed on the basis of an output signal of the laser-power measuring unit 316. Thus, even when a wavelength of light emitted from the light source 311 changes because of a temperature change or the like, it is possible to adjust the wavelength to the converted wavelength of the wavelength converting element 313. In other words, it is possible to obtain the laser beam source device that efficiently controls the fall in power of output light, has high efficiency of light usage, and has stable power.

(2) The wavelength converting element 313 is provided in the resonant structure formed by the light source 311 and the multi-layer film mirror 314. Thus, light, which is not converted into the light of the second wavelength by the wavelength converting element 313, is converted into the light of the second wavelength in a course of being reflected by the multi-layer film mirror 314 and traveling to the light source 311 and is reflected on the band-pass filter 312 to be emitted. Thus, it is possible to efficiently control the fall in power of output light and improve efficiency of light usage.

(3) The multi-layer film mirror 314 has the characteristic of reflecting the light of the first wavelength and transmitting the light of the second wavelength. Thus, it is possible to efficiently extract the light of the second wavelength converted by the wavelength converting element 313 while confining oscillating light of the light source 311 in the resonant structure.

(4) The band-pass filter multi-layer film 312B is formed by alternately stacking the high refractive index layers H and the low refractive index layers L as described above. The band-pass filter multi-layer film 312B has a band-pass characteristic near the first wavelength and can narrow-band the light of the first wavelength emitted from the light source 311. Thus, it is possible to improve conversion efficiency of the wavelength conversion in the wavelength converting element 313.

(5) The wavelength converting element 313 is the wavelength converting element of the quasi phase matching type and has conversion efficiency higher than that of wavelength converting elements of other types. Thus, it is possible to improve the effect in (1) above.

### Second Embodiment

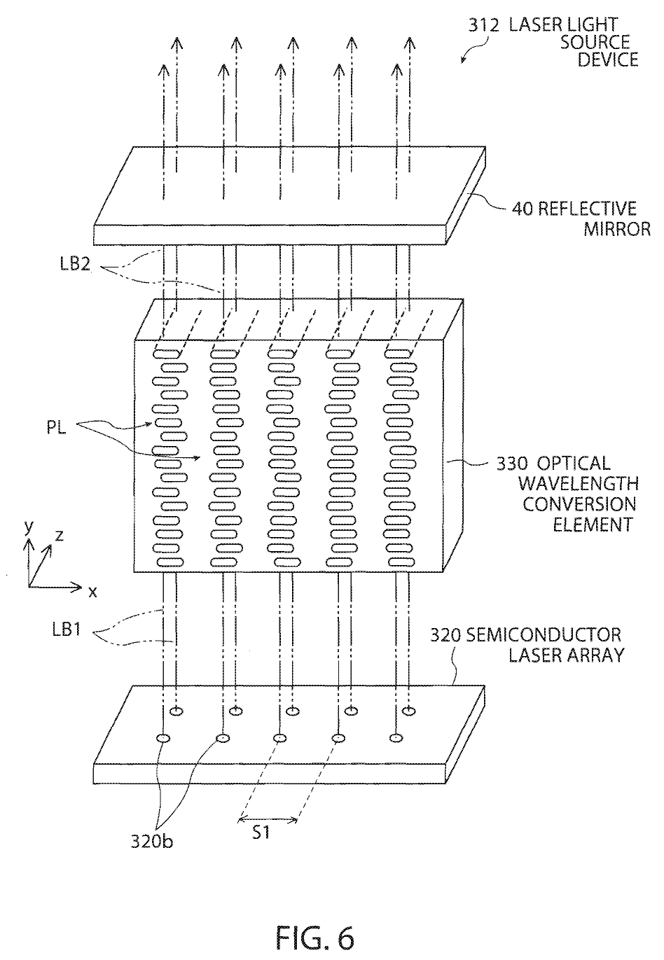

FIG. 6 is a diagram showing a schematic structure of a laser beam source device 41 according to a second embodiment of the invention. The laser beam source device 41 according to the second embodiment is different from the laser beam source device 31 according to the first embodiment in a disposed position of the band-pass filter 412. Otherwise, the laser beam source device 41 according to the second embodiment is the same as the laser beam source device 31 according to the first embodiment. Therefore, in FIG. 6, members identical with those in the first embodiment are denoted by the identical reference numerals and signs and explanations of the members are omitted or simplified. A process until output light is obtained from the laser beam source device 41 and adjustment of the tilt angle θ of the band-pass filter 412 are also the same as those in the first embodiment. Detailed explanations of the process and the adjustment are also omitted or simplified.

In FIG. 6, the laser beam source device 41 includes the light source 311, a band-pass filter 412, the wavelength converting element 313, the multi-layer film mirror 314, the reflection mirror 315, the laser-power measuring unit 316, the control unit 317, and the rotation mechanism 318. Among these components, the wavelength converting element 313, the band-pass filter 412, the multi-layer film mirror 314, and the reflection mirror 315 are provided in this order from the light source 311 side on the optical path LW of the light emitted from light source 311.

The process until output light is obtained from the laser beam source device 41 will be explained with reference to FIG. 6.

The light source 311 emits the light of the first wavelength. The light of the first wavelength emitted from the light source 311 is emitted to the wavelength converting element 313. The light of the first wavelength emitted from the light source 311 is made incident on the wavelength converting element 313.

The wavelength converting element 313 converts a wavelength of a part of the light of the first wavelength made incident thereon into a wavelength (the second wavelength) that is half the wavelength and emits the light to the band-pass filter 412.

The light emitted from the wavelength converting element 313 is made incident, on the band-pass filter 412. The band-pass filter 412 has a band-pass characteristic near the first wavelength. In the band-pass filter 412, near the fist wavelength, light having a wavelength width of about 0.5 nm in the light of the first wavelength is transmitted through the band-pass filter multi-layer film 412B. Light of wavelength widths other than the wavelength width is reflected on the band-pass filter multi-layer film 412B. In other words, narrow-banding of the light of the first wavelength made incident on the band-pass filter 412 is performed.

The band-pass filter multi-layer film 412B has a characteristic of transmitting the light of the second wavelength. It is desirable that the band-pass filter multi-layer film 412B has a transmittance equal to or higher than 80% compared with the light of the second wavelength. The light of the second wavelength transmitted through the band-pass filter 412 is emitted to the multi-layer film mirror 314. The light emitted from the band-pass filter 412 is made incident on the multi-layer film mirror 314.

In the multi-layer film mirror 314, the light converted into the light of the second wavelength in the light emitted from the wavelength converting element 313 is transmitted through the dielectric multi-layer film 314B and emitted to the reflection mirror 315.

In the light of the second wavelength emitted from the multi-layer film mirror 314 to the reflection mirror 315, the light L4 equivalent to about 0.5% of a laser power of the light of the second wavelength made incident on the multi-layer film mirror 314 is reflected to the laser-power measuring unit 316 on the reflection film 315B of the reflection mirror 315. The other light of the second wavelength is transmitted through the reflection mirror 315 and emitted from the reflection mirror 315 (the laser beam source device 41) as the laser beam LS.

On the other hand, the light (the light of the first wavelength), which is not converted into the light of the second wavelength, in the light emitted from the wavelength-converting element 313 is reflected by the dielectric multi-layer film 314B, transmitted through the band-pass filter 412 and the wavelength converting element 313, and returns to the light source 311. When the light of the first wavelength is transmitted through the wavelength converting element 313, a part of the light of the first wavelength is converted into the light of the second wavelength. The light of the first wavelength transmitted through the wavelength converting element 313 resonates with light emitted from the light source 311 anew and is amplified. In other words, the laser beam source device 41 includes a resonant structure formed between the mirror layer 311A provided in the light source 311 and the multi-layer film mirror 314.

The light converted into the light of the second wavelength when the light is transmitted through the wavelength converting element 313 is reflected by the mirror layer 311A, transmitted through the wavelength converting element 313 and the band-pass filter 412, and made incident on the multi-layer film mirror 314. The light of the second wavelength made incident on the multi-layer film mirror 314 is transmitted through the multi-layer film mirror 314. Light other than a part of the light reflected on the reflection mirror 315 is transmitted through the reflection mirror 315 and emitted from the laser beam source device 31 as the laser beam LS.

In FIG. 6, L1 indicates a laser beam that is emitted from the light source 311, converted into the light of the second wavelength by the wavelength converting element 313, transmitted through the multi-layer film mirror 314, and emitted from the reflection mirror 315 as the laser beam LS. L2 indicates light that is emitted from the light source 311, emitted without being converted into the light of the second wavelength by the wavelength converting element 313, and returns to the light source 311. L3 indicates a laser beam that is reflected by the multi-layer film mirror 314, converted into the light of the second wavelength by the wavelength converting element 313 in the course of traveling to the light source 311, reflected by the mirror layer 311A, transmitted through the multi-layer film mirror 314, and emitted from the reflection mirror 315 as the laser beam LS. In FIG. 6, L1 to L3 are shown in different positions only for convenience of explanation. However, originally, L1 to L3 are present in the same position.

Here, it is possible to replace the anti-reflective film 313B on the incidence side surface of the wavelength converting element 313 with a multi-layer film having a characteristic of transmitting the laser beam of the first wavelength and reflecting the laser beam of the second wavelength. In that case, the light converted into the light of the second wavelength when the light is transmitted through the wavelength converting element 313 is reflected on the multi-layer film of the wavelength converting element 313, transmitted through the wavelength converting element 313, and emitted to the multi-layer film mirror 314.

In the laser beam source device 41 according to the second embodiment, it is possible to realize effects same as the effects (1) and (3) to (5) in the first embodiment.

### Third Embodiment

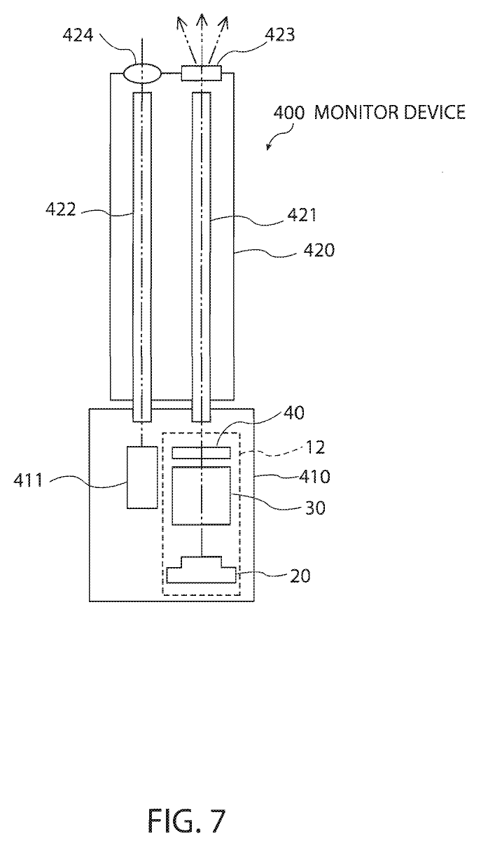

FIG. 7 is a diagram showing a schematic structure of a laser beam source device according to a third embodiment of the invention. A laser beam source device 51 according to the third embodiment is the same as the laser beam source device 31 in the first embodiment except that a dielectric multi-layer film 413C is provided on the surface on the emission side of a wavelength converting element 413 instead of the multi-layer film mirror 314 in the laser beam source device 31 of the first embodiment. Therefore, members identical with those in the first embodiment are denoted by the identical reference numerals and signs and explanations of the members are omitted or simplified. A process until output light is obtained from the laser beam source device 51 and adjustment of the tilt angle θ of the band-pass filter 312 are also the same as those in the first embodiment. Detailed explanations of the process and the adjustment are also omitted or simplified.

In FIG. 7, the laser beam source device 51 includes the band-pass filter 312, the wavelength converting element 413, and the reflection mirror 315 in order from the light source 311 side on the optical path LW serving as the first optical path of light emitted from the light source 311. The laser beam source device 51 further includes the laser-power measuring unit 316, the control unit 317, and the rotation mechanism 318.

The wavelength converting element 413 is formed in, for example, a square pole shape. The wavelength converting element 413 has a wavelength converting section 413A, has an anti-reflective film 413B on a surface on the light source 311 side (an incidence facet) of the wavelength converting section 413A, and has a dielectric multi-layer film 413C on a surface on the reflection mirror 315 side (an emission facet) of the wavelength converting section 413A.

A process until output light is obtained from the laser beam source device 51 will be explained with reference to FIG. 7.

The light of the first wavelength emitted from the light source 311 is made incident on the band-pass filter 312. Light having a wavelength width of about 0.5 nm in the light of the first wavelength is transmitted through the band-pass filter multi-layer film 312B. Light of wavelength widths other than the wavelength width is reflected on the band-pass filter multi-layer film 312B. In other words, narrow-banding of the light of the first wavelength made incident on the band-pass filter 312 is performed.

The light of the first wavelength transmitted through the band-pass filter multi-layer film 312B of the band-pass filter 312 is emitted to the wavelength converting element 413 and made incident on the wavelength converting element 413.

In the wavelength converting element 413, the wavelength converting section 413A converts a wavelength of a part of the light of the first wavelength made incident thereon into a wavelength (the second wavelength) that is half the wavelength. The light converted into the light of the second wavelength is transmitted through the dielectric multi-layer film 413C and emitted to the reflection mirror 315. On the other hand, the light (the light of the first wavelength) not converted into the light of the second wavelength is reflected by the dielectric multi-layer film 413C and travels to the light source 311.

In the light converted into the light of the second wavelength emitted to the reflection mirror 315, the laser beam L4 equivalent to about 0.5% of a laser power of the light of the second wavelength made incident on reflection mirror 315 is reflected to the laser-power measuring unit 316 on the reflection film 315B of the reflection mirror 315. The other light of the second wavelength is transmitted through the reflection mirror 315 and emitted from the reflection mirror 315 (the laser beam source device 51) as the laser beam LS.

On the other hand, a part of the light of the first wavelength reflected by the dielectric multi-layer film 413C of the wavelength converting element 413 and traveling to the light source 311 is converted into the light of the second wavelength in a course of passing through the wavelength converting section 413A again.

The light transmitted through the wavelength converting element 413 is made incident on the band-pass filer 312.

In the band-pass filter 312, the light converted into the light of the second wavelength is reflected by the band-pass filter multi-layer film 312B and travels to the wavelength converting element 413 again. On the other hand, the light (the light of the first wavelength) not converted into the light of the second wavelength is transmitted through the band-pass filter multi-layer film 312B and returns to the light source 311.

The light of the second wavelength reflected by the band-pass filter multi-layer film 312B and traveling to the wavelength converting element 413 travels through the wavelength converting element 413 and is made incident on the reflection mirror 315 from the wavelength converting element 413. Light other than a part of the light reflected on the reflection mirror 315 and branched to the second optical path is transmitted through the reflection mirror 315 and emitted from the laser beam source device 51 as the laser beam LS.

The light transmitted through the band-pass filter multi-layer film 312B and returning to the light source 311 is reflected by the mirror layer 311A (see FIG. 2) and emitted from the light source 311 again. In this way, the light of the first wavelength travels back and forth between the light source 311 and the dielectric multi-layer film 413C of the wavelength converting element 413. Consequently, the light resonates with light emitted in the laser medium 311B anew and is amplified. In other words, the laser beam source device 51 includes a resonant structure formed between the mirror layer 311A of the light source 311 and the dielectric multi-layer film 413C of the wavelength converting element 413.

In the laser beam source device 51 according to the third embodiment, in addition to the effects (1) and (3) to (5) of the first embodiment, it is possible to further realize the following effect.

The dielectric multi-layer film 413C having the function of selectively reflecting the light of the first wavelength to cause the light to travel to the light source 311 and transmitting light of other wavelength including the second wavelength is formed on the surface on the emission side of the wavelength converting element 413. Thus, the laser beam source device 51 that is reduced in the number of components, reduced in cost, and reduced in size is obtained.

### Modifications of the Embodiments

The invention is not limited to the first to third embodiments described above. Modification, alterations, and the like in a range in which the objects of the invention can be attained are included in the invention. Even in modifications described below, it is possible to obtain effects same as those of the embodiments.

As the light source 311, it is possible to use a so-called edge-emitting semiconductor laser or an LD pumped solid-state laser other than the surface-emitting semiconductor laser. When the edge-emitting semiconductor laser is used, it is preferable to provide a lens for changing light emitted from the light source 311 to parallel light between the light source 311 and the wavelength converting elements 313 and 413.

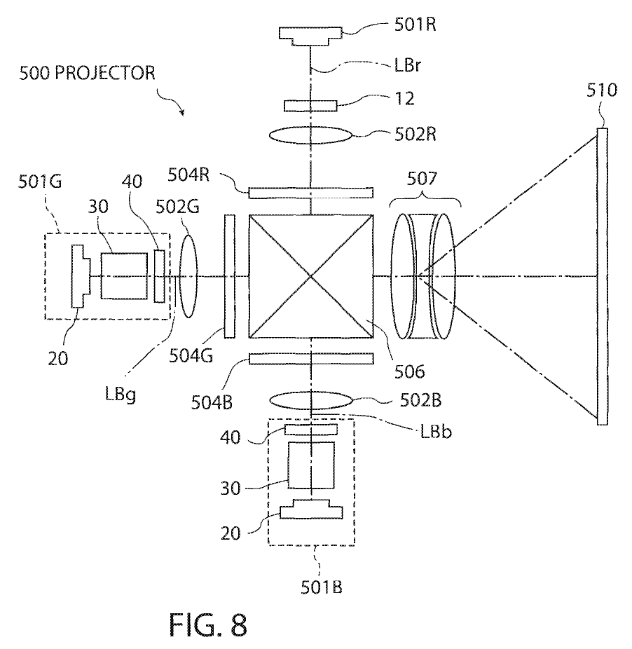

It is possible to provide a light source including plural arrayed light emitting sections as the light source 311. FIGS. 8A and 8B are schematic, diagrams showing light sources in which light emitting sections are arrayed. In a light source 321 in FIG. 8A, plural light emitting sections 322 are arranged in a row. In a light source 323 in FIG. 8B, the plural light emitting sections 322 are arranged in two rows. The number of light emitting sections and the number of rows are not limited to those shown in FIGS. 8A and 8B. In the laser beam source devices 31, 41, and 51, even when the light source in which the light emitting sections are arrayed in this way is used, areas of the light incidence surfaces and the emitting surfaces of the band-pass filter 312, the wavelength converting elements 313 and 413, the multi-layer film mirror 314, and the reflection mirror 315 only have to be expanded to areas corresponding to the array.

In this way, in the laser beam source devices 31, 41, and 51, even if the light emitting sections are arrayed in the light source, it is possible to cope with the array with a simple structure without causing an excessive increase in size of the devices. Thus, in the laser beam source devices 31, 41, and 51, even if the light emitting sections are arrayed in the light source, while keeping the effect that it is possible to efficiently control the fall in power of output light and obtain the laser beam source device having high efficiency of light usage and stable power, it is possible to efficiently link an increase in a light amount by the arraying to an increase in power of output light.

As the nonlinear optical material forming the wavelength converting elements 313 and 413, LN (LN: LiNbO₃) and LT (LT: LiTaO₃) are described as examples. Besides, inorganic nonlinear optical materials such as KNbO₃, BNN (Ba₂NaNb₅O₁₅), KTP (KTiOPO₄), KTA (KTiOAsO₄), BBO (β-BaB₂O₄), and LBO (LiB₃O₇) may be used. Further, low-molecular organic materials such as metanitroaniline, 2-methyl-4-nitroaniline, chalcone, dicyano vinyl anisole, 3,5-dimethyl-1-(4-nitrophenyl) pyrazole, and N-methoxymethyl-4-nitroaniline and organic nonlinear optical materials such as poled polymer may be used.

As the wavelength converting elements 313 and 413, a third harmonic generating element may be used instead of the SHG element described above.

### EXAMPLES OF APPLICATION OF THE LASER BEAM SOURCE DEVICES

By applying the laser beam source devices 31, 41, and 51 described above to an image display apparatus and the like, it is possible to improve efficiency of light usage in these apparatuses. Examples of application to the image display apparatus will be hereinafter described.

A structure of a projector 3 will be explained as an example of the image display apparatus to which the laser beam source device 31 according to the first embodiment is applied. FIG. 9 is a diagram showing a schematic structure of an optical system of the projector 3.

In FIG. 9, the projector 3 includes the laser beam source devices 31, liquid crystal panels 32 as optical modulation devices, incidence side sheet polarizers 331 and emission side sheet polarizers 332, a cross dichroic prism 34, and a projection lens 35. Liquid crystal light bulbs 33 are constituted by the liquid crystal panels 32, the incidence side sheet polarizers 331 provided on light incidence sides of the liquid crystal panels 32, and the emission side sheet polarizers 332 provided on light emission sides of the liquid crystal panels 32.

The laser beam source devices 31 include a light source device for red light 31R that emits a red laser beam, a light source device for blue light 31B that emits a blue laser beam, and a light source device for green light 31G that emits a green laser beam. These laser beam source devices 31 (31R, 31G, and 31B) are arranged to be opposed to three sides of the cross dichroic prism 34, respectively. In FIG. 9, the light source device for red light 31R and the light source device for blue light 31B are opposed to each other and the projection lens 35 and the light source device for green light 31G are opposed to each other across the cross dichroic prism 34. It is possible to appropriately change positions of the light source devices and the projection lens.

In the liquid crystal panels 32, for example, polysilicon TFTs (Thin Film Transistors) are used as switching elements. Color light emitted from each of the respective laser light source devices 31 is made incident on the liquid crystal panel 32 via the incidence side sheet polarizer 331. The light made incident on the liquid crystal panel 32 is modulated according to image information and emitted from the liquid crystal panel 32, Only specific linear polarized light in the light modulated by the liquid crystal panel 32 is transmitted through the emission side sheet polarizer 332 and travels to the cross dichroic prism 34.

The light emitted from the laser beam source device 31 is light well-aligned in a polarization direction. Thus, in principle, it is possible to omit the incidence side sheet polarizer 331. However, actually, the light emitted from the laser beam source device 31 is not directly used as illuminating light so often. Optical elements (e.g., a diffraction grating, a lens, a rod integrator, etc.) for processing the light emitted from the laser beam light source device 31 into light suitable for the illuminating light are often provided between the laser beam source device 31 and the liquid crystal panel 32. When the light is caused to pass such optical elements, it is likely that some irregularity occurs in polarized light. When the irregular polarized light is directly made incident on the liquid crystal panel 32, it is likely that contrast of a projected image falls and color unevenness occurs in the projected image. Thus, if the incidence side sheet polarizer 331 is provided on the incidence side of the liquid crystal panel 32 to align a direction of the polarized light made incident on the liquid crystal panel 32, it is possible to reduce the fall in contrast of the projected image and reduce occurrence of color unevenness and obtain a higher-quality image.

The cross dichroic prism 34 is an optical element that combines color lights modulated by the liquid crystal panels 32 to form a color image. The cross dichroic prism 34 is formed in a square shape in a plan view obtained by bonding four rectangular prisms. Two kinds of dielectric multi-layer films are provided in an X shape in interfaces of the four rectangular prisms. These dielectric multi-layer films reflect the color lights emitted from the liquid crystal panels 32 opposed to one another and transmit the color light emitted from the liquid crystal panel 32 opposed to the projection lens 35. In this way, the color lights modulated by the liquid crystal panels 32 are combined to form a color image. The projection lens 35 is constituted as a set lens formed by combining plural lenses. The projection lens 35 enlarges and projects the color image.

In the projector 3 constituted as described above, the laser beam source devices 31 are used. Thus, it is possible to obtain a projector with improved efficiency of light usage.

In this example of application, the laser beam source devices 31 (31R, 31G, and 31B) according to the first embodiment are used. However, a part or all of the laser beam source devices 31 may be replaced with the laser beam source devices 41 and 51 according to the other embodiments.

Moreover, a part of the laser beam source devices 31 (31R, 31G, and 31B) may be replaced with a laser beam source device that directly uses a wavelength of a fundamental wave laser.

In this example of application, the example of the projector in which the three liquid crystal panels as the optical modulation devices are used is explained. However, it is also possible to apply the laser beam devices 31, 41, and 51 according to the first to third embodiments to a projector in which one, two, or four or more liquid crystal panels serving as optical modulation devices are used.

In this example of application, the transmission projector is explained. However, it is also possible to apply the laser beam source devices 31, 41, and 51 according to the first to third embodiments to a reflection projector. Here, “transmission” means that an optical modulation device is a type for transmitting light. “Reflection” means that an optical modulation device is a type for reflecting light.

The light modulation device is not limited to the liquid crystal panel 32 and may be, for example, a device in which a micro-mirror is used.

As the projector, there are a front type projector that performs image projection from a direction in which a projection surface is observed and a rear type projector that performs image projection from a side opposite to the direction in which the projection surface is observed. It is possible to apply the laser beam source devices 31, 41, and 51 according to the first to third embodiments to both the types.

It is also possible to apply the laser beam source devices 31, 41, and 51 to a projector of a system that has, as an optical modulation device, a light-source control device that controls an electric current or the like inputted to a laser beam source device according to an image signal to cause the laser beam source device to emit a laser beam modulated according to the image signal and has scanning means for causing the laser beam emitted from the laser beam source device to scan a display surface to display an image.

Moreover, in this example of application, the projector including the projection lens 35 that enlarges and projects an image is introduced as an example of the image display apparatus to which the laser beam source device 31 is applied. However, it is also possible to apply the laser beam source devices 31, 41, and 51 according to the first to third embodiments to an image display apparatus and the like in which the projection lens 35 is not used.

The entire disclosure of Japanese Patent Application Nos. 2006-293634, filed Oct. 30, 2006 and 2007-147742, filed Jun. 4, 2006 are expressly incorporated by reference herein.

What is claimed is:

1. A laser beam source device comprising:
a light source that emits light of a first wavelength;
a multi-layer film mirror that reflects the light emitted from the light source and forms a resonator, the multi-layer film mirror having a dielectric multi-layer film having a characteristic of reflecting light of the first wavelength and transmitting light of a second wavelength;
a wavelength converting element that is provided between the light source and the multi-layer film mirror on a first optical path formed by light emitted from the light source and converts a wavelength of a part of the light of the first wavelength entered into the second wavelength different from the first wavelength;
a band-pass filter that is provided between the light source and the multi-layer film mirror on the first optical path formed by the light emitted from the light source and in which a band-pass filter multi-layer film having a band-pass characteristic near the first wavelength is formed;
a reflection mirror that branches the light transmitted through the multi-layer film mirror to the first optical path and a second optical path;
a laser-power measuring unit that measures power of the light branched to the second optical path; and
a control unit that performs, on the basis of an output signal of the laser-power measuring unit, angle adjustment for displacing a tilt angle of the band-pass filter with respect to the first optical path.

2. A laser beam source device according to claim 1, wherein the dielectric multi-layer film that forms the multi-layer film mirror is formed on a surface on an emission side of the wavelength converting element.

3. A laser beam source device according to claim 1, wherein the band-pass filter is disposed between the light source and the wavelength converting element.

4. A laser beam source device according to claim 1, wherein the band-pass filter is disposed between the multi-layer film mirror and the wavelength converting element.

5. A laser beam source device according to claim 3, wherein the band-pass filter multi-layer film further has a characteristic of reflecting a laser beam of the second wavelength.

6. A laser beam source device according to claim 4, wherein the band-pass filter multi-layer film further has a characteristic of transmitting the laser beam of the second wavelength.

7. A laser beam source device according to claim 1, wherein high refractive index layers H and low refractive index layers L are alternately stacked in the band-pass filter multi-layer film and, when the first wavelength is λ, optical film thicknesses of the layers are 0.236 λH, 0.355 λL, 0.207 λH, 0.203 λL (0.25 H, 0.25 λL)n, 0.5 λH, (0.25 λL, 0.25 λH)n, 0.266 λL, 0.255 λH, 0.248 λL, 0.301 λH, and 0.631 λL in order from the wavelength converting element side, where, n is a value in a range of 3 to 10 and indicates the number of repetition of repeated stacking of the layers in the parentheses.

8. A laser beam source device according to claim 1, wherein the light source includes plural arrayed light emitting sections.

9. A laser beam source device according to claim 1, wherein the wavelength converting element is a wavelength converting element of a quasi phase matching type.

10. An image display apparatus comprising:
a laser beam source device according to claim 1; and
an optical modulation device that modulates, according to image information, a laser beam emitted from the laser beam source device.
